(19) United States
(12) Patent Application Publication
(10) Pub. No.: US 2018/0222604 A1
(43) Pub. Date: Aug. 9, 2018

(54) SATELLITE PROPELLED BY LASER ABLATION

(71) Applicant: THALES, Courbevoie (FR)

(72) Inventor: Alexandre GARUS, AURIBEAU SUR SIAGNE (FR)

(21) Appl. No.: 15/886,767

(22) Filed: Feb. 1, 2018

(30) Foreign Application Priority Data
Feb. 9, 2017 (FR) 1700147

(51) Int. Cl. B64G 1/24; B64G 1/40; B64G 1/10; B64G 1/00

(52) U.S. Cl. CPC B64G 1/242; B64G 1/405; F02K 9/94; B64G 1/007; B64G 1/1078

(57) ABSTRACT

A satellite propelled by laser ablation comprises: a device for managing the attitude and the orbit of the satellite; a device for capturing and potentially for processing the target spaceborne body; a device for external communication; a laser ablation propulsion device comprising one or more lasers and a module for managing the one or more lasers that is suitable for determining the one or more laser beams to be generated on the captured target spaceborne body according to the movement desired for the satellite; and a device for visually inspecting the target spaceborne body.

### CROSS-REFERENCE TO RELATED APPLICATIONS

This application claims priority to foreign French patent application No. FR 1700147, filed on Feb. 9, 2017, the disclosure of which is incorporated by reference in its entirety.

### FIELD OF THE INVENTION

The invention pertains to a satellite propelled by laser ablation.

Propulsion by laser ablation consists in focusing the beam of a laser on a combustible solid, the satellite being propelled by the ejection of matter in the form of plasma.

The present invention pertains to the fields of repurposing orbital junk, of changing orbits, and of specific mission scenarios of reaching orbit, de-orbiting or satellite intervention.

It is desirable then to limit the cost of changing orbits, to repurpose space junk, and to carry out interventions on various satellites at low cost.

### BACKGROUND

The solutions currently used for changing orbit consist in loading the satellites while on Earth with the propellant required to generate thrust when they are in orbit. This propellant may be intended for chemical or electric propulsion.

These solutions have numerous drawbacks, including the following:

since chemical propulsion has a low specific impulse (ISP), the mass to be loaded on board the satellite is very substantial, the current cost of putting 1 kg into low Earth orbit being of the order of €20 k;

electric propulsion has a higher ISP, which decreases the on-board mass. A noble gas is generally used, typically xenon, for which the current value is about €10 k/kg, to which the cost of putting it into orbit must be added. For electric propulsion, a higher ISP however entails lower thrust and hence a longer time taken to change orbit.

Alternative propulsion solutions are also known in the literature and some have been demonstrated on the ground. All of the proposed alternative solutions involve using a propellant that is launched along with the satellite, using a propellant that is refined on Earth and launched into a storage orbit, the cost of which is prohibitive, or extracting water from a celestial body, which involves seeking out an asteroid and finding enough water to extract therefrom.

Regarding the repurposing of space junk, a very substantial mass of satellites has been placed in orbit. Numerous old satellites have become junk, which is a threat to current satellites. It is therefore envisaged to de-orbit them or to place them in orbits referred to as graveyard orbits. These constraints will become increasingly important with the development of space law.

Envisaged solutions (which have yet to be implemented) to these problems are the following:
single- (de-orbiting a single item of space junk) or multiple-use de-orbiters (de-orbiting a multiple items of space junk). A single-use de-orbiter entails constructing and launching one satellite to de-orbit another. The cost is prohibitive. Reusing a de-orbiter is clearly more attractive. However, at the current time, there is still no market other than the institutional market for this type of mission. Moreover, the de-orbiter is able to hold enough propellant only for a limited number of missions. The speed difference (delta-V) that can be achieved for, for example, performing an orbit-change manoeuvre is limited from the moment when the satellite is put into operation.
using very-high-power lasers, of the order of MW, based on the ground to bring small items of space junk down into the atmosphere.
creating a recycling plant in orbit, which does not provide a solution for recovering junk in different orbits.

### SUMMARY OF THE INVENTION

One aim of the invention is to overcome the aforementioned problems.

Therefore, according to one aspect of the invention, a satellite propelled by laser ablation is provided comprising:
a device for managing the attitude and the orbit of the satellite;
a device for capturing and potentially for processing the target spaceborne body;
a device for external communication;
a laser ablation propulsion device comprising at least one laser comprising a module for managing the one or more lasers that is suitable for determining the one or more laser beams to be generated on the captured target spaceborne body according to the movement desired for the satellite, and a device for visually inspecting the target spaceborne body.

Such a satellite may therefore use a target spaceborne body, such as an item of orbital junk, as a propellant reserve used for propulsion by laser ablation.

The impact of one or more lasers on a target spaceborne body generates force by vaporizing the surface thereof, and serves as a means of propulsion while transforming a material into gas.

Such a satellite may recover a first item of space junk allowing a propellant reserve to be formed, carry out one or more missions (orbital maintenance, recovery and positioning of another satellite, etc.) by using the space junk or debris to achieve the speed difference to be produced, for example, to perform an orbit-change manoeuvre. The item of space junk is consumed as it goes along. The satellite may next recover another item of junk to top up its propellant reserve.

Thus, it is therefore not necessary to put propellant into orbit (€20 k/kg), since the satellite is able to use in-situ resources. The satellite does not hold any propellant on board for its entire operating life, thereby decreasing its launch mass and thrust requirement when achieving speed differences.

Items of orbital junk become propellant reserves; their value is no longer negative via the cost of a de-orbiting mission but becomes positive in comparison to the cost of putting the same mass of propellant into orbit from the ground. The items of space junk are gradually vaporized and present a much lower risk to other satellites. Using space junk in this way is simpler than developing an orbital reprocessing plant.

The satellite according to the invention uses the mass of orbital objects as propellant using propulsion by laser ablation, thereby allowing numerous missions to be carried out including active debris removal (ADR), positioning, orbital maintenance, and retrieving and exploiting asteroids.

In one embodiment, the satellite comprises a device for managing the attitude of the target spaceborne body to be captured controlling the device for managing one or more lasers and suitable for determining the attitude and/or the angular velocity of rotation of a target spaceborne body, and the distance separating the target spaceborne body and the satellite.

Thus, it is possible to manage the spin or rotation of the target spaceborne body about itself, and/or its attitude, by improving interception, while limiting energy consumption, and while limiting the risk of colliding with the target spaceborne body, in particular by decreasing the spin of the target spaceborne body, i.e. by limiting the rotation of the target spaceborne body about itself.

According to one embodiment, the device for managing the attitude of the target spaceborne body to be captured comprises a lidar, and/or a stereoscopic camera, and/or a camera provided with a device for determining distance on the basis of a temporal succession of images from the camera, and/or a device configured to take into account a digital model that is representative of the shape and/or of the texture and/or of the materials of the target spaceborne body.

Thus, by virtue of knowledge of the attitude of the target element, the control loop is able to determine the torque to be applied to correct the attitude of the target element. By virtue of knowledge of the distance, it is possible to focus the laser better and hence to control the force, and hence the torque applied to the target element, more finely.

In one embodiment, the device for managing the attitude and the orbit of the satellite comprises a sun sensor, and/or a magnetometer, and/or a star tracker, and/or an Earth sensor, and/or a satellite navigation system receiver, and/or thrusters, and/or reaction wheels, and/or gyroscopic actuators, and/or magneto torquers bars, and/or an accelerometer, and/or an inertial measurement unit.

Thus, it is possible to determine and to control the attitude and the orbit of the satellite.

According to one embodiment, the device for managing the attitude of the target spaceborne body to be captured is configured to take into account a solar disturbance model and/or an atmospheric disturbance model and/or a magnetic disturbance model.

Thus, it is possible to determine the attitude of the target spaceborne body with a higher degree of accuracy.

According to one embodiment, the device for capturing and potentially for processing the target spaceborne body comprises a launcher/satellite interface and/or an attachment device, such as a gripper or a harpoon, that is attached to the satellite by an intermediate element such as a panel, a robotic arm, or a cable.

In one embodiment, a laser is continuous or pulsed, fixed or movable with respect to the satellite, potentially provided with a beam-guiding system, and potentially provided with an assembly for protecting the optical system of the laser using a gas stream.

According to one embodiment, the device for capturing and for processing the target spaceborne body comprises a device for cutting up the target spaceborne body, and/or a device for compacting the target spaceborne body, and/or a device for melting/extruding the target spaceborne body.

Thus, it is possible to shape and to store a piece of propellant material.

In one embodiment, the satellite comprises a nozzle for channelling the plasma stream created by the impact of the one or more laser beams on the target spaceborne body.

According to one embodiment, the satellite comprises a magnetostatic device for controlling and accelerating the plasma jet created by the impact of the one or more laser beams on the target spaceborne body.

In one embodiment, the satellite comprises an electrostatic device for accelerating the plasma jet created by the impact of the one or more laser beams on the target spaceborne body.

According to one embodiment, the satellite comprises a radiofrequency-wave device for accelerating the plasma jet created by the impact of the one or more laser beams on the target spaceborne body.

According to another aspect of the invention, a space propulsion method is also provided that comprises the steps consisting in:

capturing and potentially processing a target spaceborne body; and

using the target spaceborne body as propellant for propulsion by laser ablation.

### BRIEF DESCRIPTION OF THE DRAWINGS

The invention will be better understood on studying a few embodiments described by way of completely non-limiting examples and illustrated by the appended drawings, in which:

FIG. 1 schematically illustrates the operating principle of a satellite according to one aspect of the invention;

FIG. 2 schematically illustrates a satellite according to another aspect of the invention;

FIG. 3 schematically illustrates an exemplary satellite nozzle according to one aspect of the invention;

FIG. 4 schematically illustrates an exemplary nozzle with an electrostatic gate according to one aspect of the invention; and

FIG. 5 schematically illustrates an exemplary compacting and melting device.

### DETAILED DESCRIPTION

In the various figures, the elements that have the same references are identical.

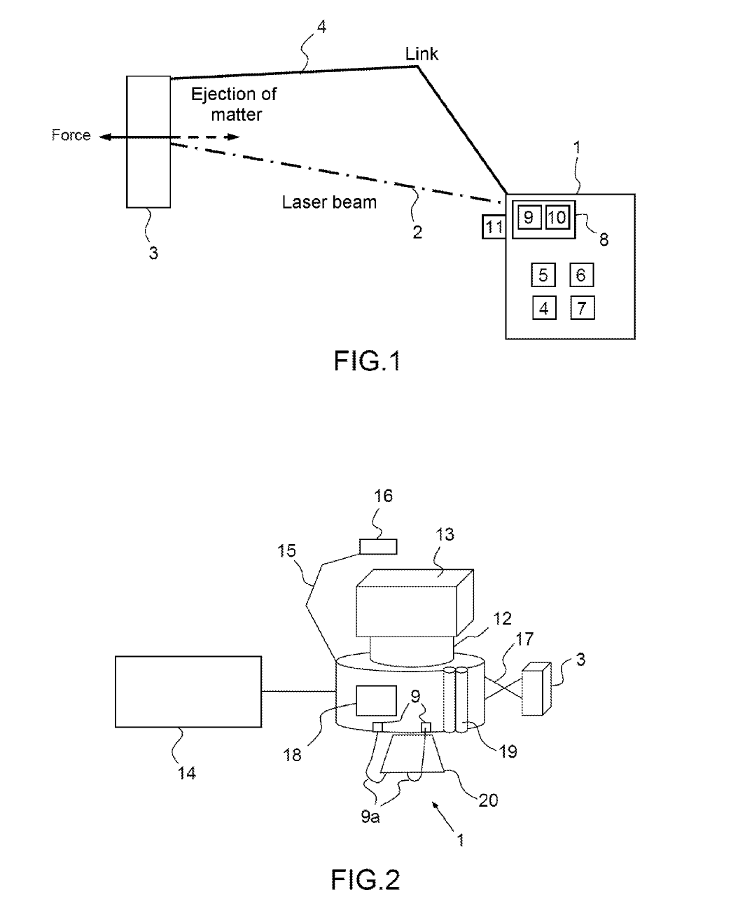

FIG. 1 shows, in a simplified manner, one completely non-limiting embodiment of a satellite 1 according to one aspect of the invention.

The principle of thrust is illustrated thereby. The impact of a laser beam 2 produces a plasma and ejects matter at the site of the impact. This ejection of matter creates a reactive force in the opposite direction. Considering that the target spaceborne body 3 and the satellite 1 are mechanically linked by a device 4 for capturing the target spaceborne body 3, the overall assembly is subject to an acceleration according to the well-known relationship F=ma.

The calculation of the force generated is given by the following formulae.

The coupling coefficient Cₘ, in newtons per watt, for a pulsed laser in a steady plasma state is given by the following relationship:

$${C}_{m} = 1.84 e - 4 \frac{{Ψ}^{\frac{9}{16}} \cdot {A}^{- \frac{1}{8}}}{{( I \cdot λ \cdot \sqrt{τ} )}^{\frac{1}{4}}}$$

in which:
I is the intensity of the laser, in amperes
λ is the wavelength of the laser, in metres
τ is the duration of the pulse, in seconds
A the average atomic mass number of the surface, which is dimensionless

$$Ψ = \frac{A}{2} \cdot {[ {Z}^{2} ( Z + 1 ) ]}^{\frac{1}{3}}$$

$$where Z = \frac{{n}_{e}}{{n}_{i}}$$

is an ionization coefficient close to 1 in the steady state, which is dimensionless

Based on this equation, it is possible to determine the force generated in a laser impact by knowing the mean power in watts delivered by the laser. The mean force exerted is given by the following relationship:

Fₘₑₐₙ=Cₘ·Pₘₑₐₙ

It is possible to vary the integral of the force over a duration by modulating the number of pulses per unit time and/or by modulating the duration of the laser pulses, and/or by modifying the wavelength of the laser, and/or by modifying the intensity of the laser.

The intensity of the laser may be modified using a collimation device. Specifically, the intensity is expressed according to the following relationship:

$$I = \frac{{P}_{max}}{S}$$

in which:

Pₘₐₓ is the maximum power of the laser, in watts

S is the area on which the laser is concentrated, in m².

It is therefore possible to decrease the intensity of the laser by delocalizing it, resulting in an increase in the coupling coefficient and hence an increase in the applied force.

The point of impact on the target at a given instant in time may be selected in different ways, preferably on the basis of a digital model of the surfaces of the target spaceborne body. For each of the elementary surfaces, it is first necessary to determine whether they are visible from the corresponding laser, for example using a ray-tracing algorithm. Only those surfaces that are visible should be considered. For each of these surfaces, it is necessary to calculate the angle between the normal to the surface and the vector from the centre of the surface to the laser. This angle affects the focus of the laser by spreading the light spot created by the laser.

Given the same laser pulse characteristics, it is possible to modify the level of force generated by choosing the point of impact on the basis of this information.

Lastly, it is possible to modulate the integral of the force via the frequency of repetition of the pulses per unit time.

The satellite 1 comprises a device 5 for managing the attitude and the orbit of the satellite 1, and may comprise a device 6 for managing the attitude of the target spaceborne body to be captured controlling the device for managing one or more lasers. The satellite 1 also comprises a device 4 for capturing and potentially for processing the target spaceborne body 3. The satellite 1 also comprises a device 7 for external communication, and a laser ablation propulsion device 8 comprising one or more lasers and a module for managing 10 the one or more lasers 9 that is suitable for determining the one or more laser beams 2 to be generated on the captured target spaceborne body 3 according to the movement desired for the satellite 1. The lasers may either be dedicated to one of the devices 5, 6 and 8 exclusively, or be shared between these devices.

The satellite 1 also comprises a device 11 for visually inspecting the target spaceborne body 3, such as a camera located on the satellite 1 or on the device 4 for capturing the target spaceborne body 3.

The device for managing 6 the attitude of the target spaceborne body 3 to be captured is suitable for determining the attitude and/or the angular velocity of rotation of the target spaceborne body 3, and the distance separating the target spaceborne body 3 and the satellite 1.

The device for managing 6 the attitude of the target spaceborne body 3 to be captured may comprise a lidar, and/or a stereoscopic camera, and/or a camera provided with a device for determining distance on the basis of a temporal succession of images from the camera, and/or a device configured to take into account a digital model that is representative of the shape and/or of the texture and/or of the materials of the target spaceborne body 3.

The device for managing 5 the attitude and the orbit of the satellite 1 may comprise a sun sensor, and/or a magnetometer, and/or a star tracker, and/or an Earth sensor, and/or a satellite navigation system receiver, and/or thrusters, and/or reaction wheels, and/or gyroscopic actuators, and/or magneto torque bars, and/or an accelerometer, and/or an inertial measurement unit.

The device for managing 6 the attitude of the target spaceborne body 3 to be captured may be configured to take into account a solar disturbance model and/or an atmospheric disturbance model and/or a magnetic disturbance model.

The device 4 for capturing and potentially for processing the target spaceborne body 3 comprises an attachment device, such as a gripper, a harpoon, or a launcher/satellite interface, i.e. a device for attaching the satellite to the rocket that launched it, for example a magnetic or mechanical device, that is attached to the satellite by an intermediate element such as a panel, a robotic arm, or a cable.

A laser may be continuous or pulsed, fixed or movable with respect to the satellite 1, potentially provided with a beam-guiding system, and potentially provided with an assembly for protecting the optical system of the laser using a gas stream.

The device 4 for capturing and for processing the target spaceborne body may comprise a device for cutting up the target spaceborne body 3, and/or a device for compacting the target spaceborne body 3, and/or a device 18 for melting/extruding the target spaceborne body 3.

The satellite 1 may comprise a nozzle 20 for channelling the plasma stream created by the impact of the one or more laser beams 2 on the target spaceborne body 3.

The satellite 1 may comprise a magnetostatic device for controlling the plasma jet created by the impact of the one or more laser beams 2 on the target spaceborne body 3.

The satellite 1 may comprise an electrostatic or magnetohydrodynamic device for accelerating the plasma jet created by the impact of the one or more laser beams 2 on the target spaceborne body 3.

The satellite 1 may comprise a radiofrequency-wave device for accelerating the plasma jet created by the impact of the one or more laser beams 2 on the target spaceborne body 3.

FIG. 2 illustrates a satellite 1 having a launcher/satellite interface 12 allowing it to recover another satellite 13 requiring a change of orbit. The satellite 1 is provided with photovoltaic solar panels 14 that are used to generate electricity for an electrical energy production and/or storage system.

In this embodiment, the device 4 for capturing and potentially for processing a target spaceborne body 3 comprises a robotic capture arm 15, potentially provided with interchangeable tools 16, for capturing a target spaceborne body 3 or equally for carrying out technical work on another satellite.

The device 4 for capturing and potentially for processing a target spaceborne body 3 also comprises a gripper for holding 17 a target spaceborne body 3 that was previously captured by the arm 15. The device 4 for capturing and potentially for processing a target spaceborne body 3 also comprises an oven/compactor assembly 18 allowing it to melt and to compact one or more target spaceborne bodies 3. After compacting, bars of propellant 19 are obtained that may be stored in reserve.

The satellite 1 comprises a nozzle 20 for channelling the plasma stream created by the impact of the one or more laser beams 2, in this instance of the two lasers 9, on the target spaceborne body 3, which lasers are provided with optical fibres 9a.

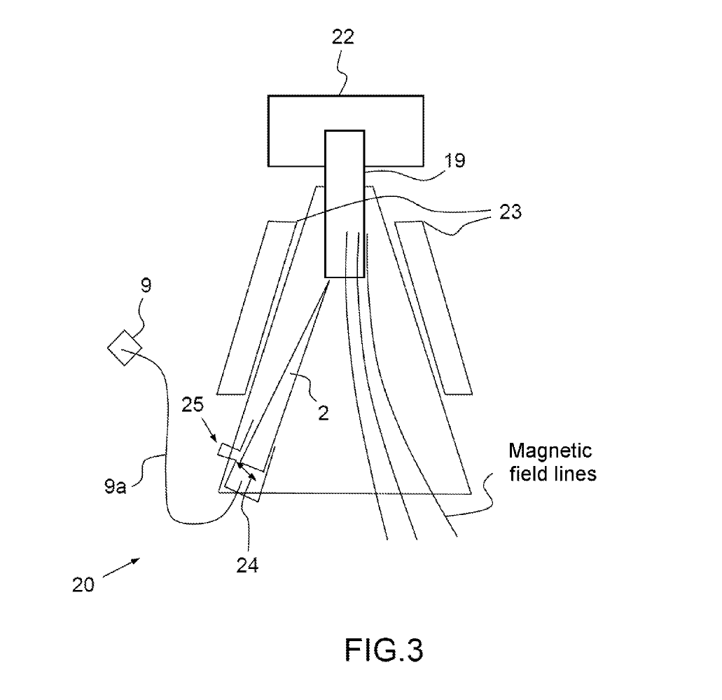

FIG. 3 shows an exemplary nozzle 20, provided with a mechanism for holding and for advancing a bar of propellant 19. A remote laser 9 is shown with an optical fibre 9a for emitting a laser beam 2 in the direction of the bar of propellant 19.

The nozzle 20 may comprise magnetic coils 23 for better channelling the plasma stream created by the impact of the one or more laser beams 2 on the target spaceborne body or propellant.

The nozzle 20 may comprise an optical system 24 for more precisely focusing the laser beam, and/or a gas stream 25 for protecting the optical system from the particle stream created by the impact of the laser on the bar of propellant 19.

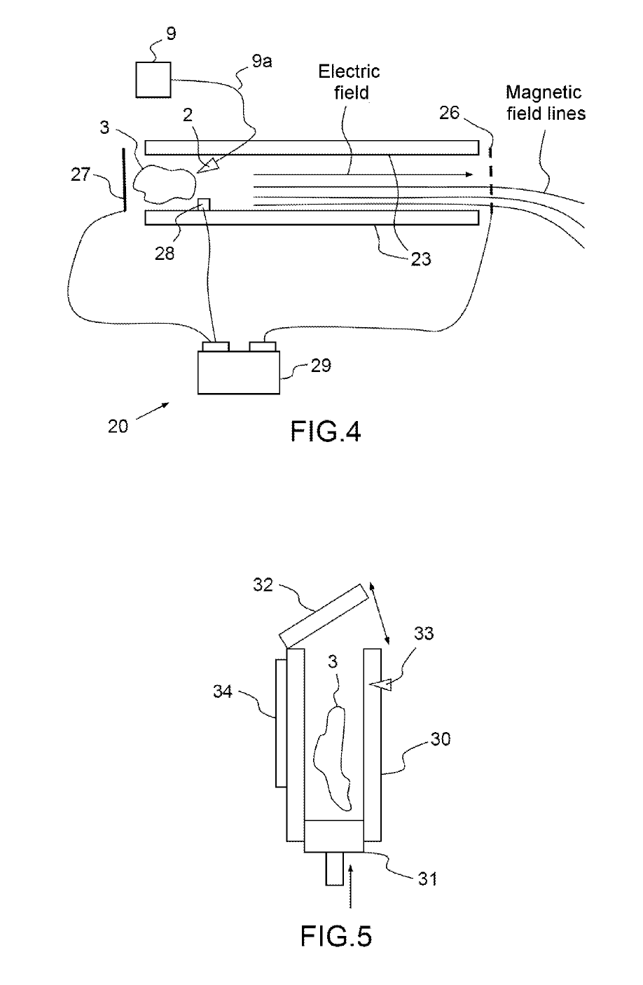

FIG. 4 schematically shows a nozzle 20 with a gate 26, and a remote laser 9 provided with an optical fibre 9a. The nozzle comprises a plate 27 allowing a uniform electric field to be created within the cavity of the nozzle, and an electrode 28. A high-voltage generator 29 links the gate 26 and the plate 27.

FIG. 5 shows an exemplary oven/compactor assembly 18, comprising a cylinder provided with a piston 31, with a cover 32, and with a system for injecting an optional binder, for the purpose of melting and/or binding all or some of a target spaceborne body 3.

The emission of a laser beam 2 allows a force to be generated that generates a torque on the captured, and potentially processed, target spaceborne body 3.

The device 6 for managing the attitude of a target spaceborne body 3 to be captured also manages the one or more lasers 9 and determines the attitude of the target spaceborne body 3.

The device 6 for managing the attitude of a target spaceborne body 3 may comprise a force/torque generator, in this instance the one or more lasers 9. The device 6 for managing the attitude of a target spaceborne body 3 also comprises elements for managing the direction of the one or more lasers 9, elements for managing the focus of the one or more lasers 9, elements for managing the level of torque generated by the one or more lasers 9, and elements for protecting the optical system of the one or more lasers 9.

The elements for managing the direction of the one or more lasers 9 may comprise elements for controlling the attitude of the satellite 1, and/or a mechanism for orienting the one or more lasers 9, and/or a mechanism for orienting the optical fibres 9a, and/or an optical assembly that can be oriented. As a variant, the satellite 1 may comprise a plurality of pre-oriented lasers.

The elements for managing the focus of a laser 9 may comprise lenses and/or mirrors.

The elements for managing the level of torque generated by the one or more lasers 9 may comprise an assembly for modulating the amplitude of the one or more lasers 9, and/or an assembly for modulating the pulse duration of the one or more lasers 9, and/or an assembly for modulating the focus of the one or more lasers 9.

The elements for protecting the optical system of a laser 9 may comprise a gas stream in front of the optical assembly.

The operation of the device 6 for managing the attitude of the target spaceborne body 3 to be captured is described below.

The device 5 for managing the attitude and the orbit of the satellite 1 determines the absolute position of the satellite 1, and the attitude of the satellite 1.

The device 6 for managing the attitude of the target spaceborne body 3 to be captured determines the relative position of the target spaceborne body 3 with respect to the satellite 1.

Known algorithms are used for these purposes, either directly on the basis of raw data, or on the basis of data that are filtered to improve estimation. These filters may be simple filters that reject a particularly noisy band of frequencies, or else a more elaborate filter such as a Kalman filter.

A setpoint is next calculated for the attitude and/or for the angular velocity of rotation of the target spaceborne body 3 using either a constant value or a value that varies with time.

An error is next calculated for the attitude and/or for the angular velocity of rotation of the target spaceborne body 3 by differencing between the estimated angular velocity and/or the estimated attitude, and the corresponding setpoint.

The attitude and the orbit of the satellite 1 is then controlled, and the device 6 for managing the attitude of the target spaceborne body 3 to be captured calculates a torque to be generated on the target spaceborne body 3, then the point on the target spaceborne body 3 to be impacted, the modulation of the focal length and the level of torque.

The device 6 for managing the attitude of the target spaceborne body 3 next calculates the direction of the beam of the one or more lasers 9 and manages the direction of the one or more laser beams 2.

The device 6 for managing the attitude of the target spaceborne body 3 also manages the focus of the one or more beams 2 of the one or more lasers 9, and the level of torque generated.

The conventional algorithms used are not described in detail.

Here follows the description of the principle of modulating the torque applied to the target spaceborne body 3.

The torque applied to the target spaceborne body 3 is given by the equation:

\vec{T}=\vec{OP} ∧ \vec{F}

in which:
\vec{T} represents the torque applied to the target element, in N·m;
\vec{F} is the force created by the one or more lasers 9, in N;
\vec{OP} is the vector linking the centre of gravity of the target spaceborne body 3 and the point of application of the force \vec{F};

It is therefore possible to vary the torque applied to the target spaceborne body 3 by varying the leverage (\vec{OP}) at constant force \vec{F}, and/or by varying the force \vec{F} applied (in that direction or normal thereto).

The coupling coefficient, in N/W, for a pulsed laser in a steady plasma state is given by the following equation:

$${C}_{m} = 1.84 e - 4 \frac{{Ψ}^{\frac{9}{16}} \cdot {A}^{- \frac{1}{8}}}{{( I \cdot λ \cdot \sqrt{τ} )}^{\frac{1}{4}}}$$

in which
I represents the intensity of the laser, in W/cm²;
λ represents the wavelength of the laser, in m;
τ represents the duration of the pulse, in s;
A represents the average atomic mass number of the surface of the target spaceborne body 3 at the site of impact; and
Ψ represents an ionization coefficient close to 1 in the steady state, which is dimensionless.

Based on this equation, it is possible to determine the force generated in a laser beam impact by knowing the mean power in W delivered by the laser beam. The mean force exerted is used to calculate the speed difference delta-V for changes of orbit, and is given by the following equation:

Fₘₑₐₙ=Cₘ·Pₘₑₐₙ

in which
Fₘₑₐₙ represents the norm of the force to be generated on the target spaceborne body 3 at the site of a laser impact, in N;
Cₘ represents the coupling coefficient for a pulsed laser that is considered to be in a steady plasma state, in N/W; and
Pₘₑₐₙ represents the mean power of the laser in question, in W.

It is possible to vary the integral of the force over a duration:

by modulating the number of pulses per unit time;

by modulating the duration of the laser pulses:

by modifying the wavelength of the laser; or

by modifying the intensity of the laser

The intensity of the laser may be modified using a collimation device. Specifically, the intensity is expressed by the following equation:

$$I = \frac{{P}_{max}}{S}$$

in which:

Pₘₐₓ represents the maximum power of the laser, in W; and

S represents the area on which the laser is concentrated, in cm²

It is therefore possible to decrease the intensity of the laser by delocalizing it. This then results in an increase in the coupling coefficient and hence an increase in the applied force.

The point of impact on the target spaceborne body 3 at a given instant in time may be selected in different ways, preferably on the basis of a digital model of the surfaces of the target spaceborne body 3. For each of the elementary surfaces, it is first necessary to determine whether they are visible from the laser 9 in question, for example using a ray-tracing algorithm. Only those surfaces that are visible should be considered. For each of these surfaces, it is necessary to calculate:

the vector product between a vector linking the centre of gravity of the target spaceborne body and the point of impact of the laser on the target and a normalized vector of the direction normal to the surface at the point of impact and in the direction of the interior of the target spaceborne body. This product gives the level of leverage that can be reached by a laser-beam impact on the surface in question; and

the angle between the normal to the surface and the vector linking the point of impact of the laser in question. This angle affects the focus of the laser by “spreading” the light spot created by the laser. It is considered to be a point of impact even if, in reality, it is a small area of impact of the laser in question, which may be likened to a point, such as the central point of this small area.

Given the same laser pulse characteristics, it is possible to modify the level of torque generated by choosing the point of impact on the basis of this information.

1. A satellite propelled by laser ablation comprising:
a device for managing the attitude and the orbit of the satellite;
a device for capturing and potentially for processing the target spaceborne body;
a device for external communication;
a laser ablation propulsion device comprising one or more lasers and a module for managing the one or more lasers that is suitable for determining the one or more laser beams to be generated on the captured target spaceborne body according to the movement desired for the satellite; and
a device for visually inspecting the target spaceborne body.

2. The satellite according to claim 1, comprising a device for managing the attitude of a target spaceborne body to be captured controlling one or more lasers and suitable for determining the attitude and/or the angular velocity of rotation of the target spaceborne body, and the distance separating the target spaceborne body and the satellite.

3. The satellite according to claim 1, wherein the device for managing the attitude of the target spaceborne body to be captured comprises a lidar, and/or a stereoscopic camera, and/or a camera provided with a device for determining distance on the basis of a temporal succession of images from the camera, and/or a device configured to take into account a digital model that is representative of the shape and/or of the texture and/or of the materials of the target spaceborne body.

4. The satellite according to claim 1, wherein the device for managing the attitude and the orbit of the satellite comprises a sun sensor, and/or a magnetometer, and/or a star tracker, and/or an Earth sensor, and/or a satellite navigation system receiver, and/or nozzles, and/or reaction wheels, and/or gyroscopic actuators, and/or magnetorquers, and/or an accelerometer, and/or an inertial measurement unit.

5. The satellite according to claim 1, wherein the device for managing the attitude of the target spaceborne body to be captured is configured to take into account a solar disturbance model and/or an atmospheric disturbance model and/or a magnetic disturbance model.

6. The satellite according to claim 1, wherein the device for capturing and potentially for processing the target spaceborne body comprises a launcher/satellite interface and/or an attachment device that is attached to the satellite by an intermediate element.

7. The satellite according to claim 1, wherein a laser is continuous or pulsed, fixed or movable with respect to the satellite, potentially provided with a beam-guiding system, and potentially provided with an assembly for protecting the optical system of the laser using a gas stream.

8. The satellite according to claim 1, wherein the device for capturing and for processing the target spaceborne body comprises a device for cutting up the target spaceborne body, and/or a device for compacting the target spaceborne body, and/or a device for melting/extruding the target spaceborne body.

9. The satellite according to claim 1, comprising a nozzle for channelling the plasma stream created by the impact of the one or more laser beams on the target spaceborne body.

10. The satellite according to claim 1, comprising a magnetostatic device for controlling the plasma jet created by the impact of the one or more laser beams on the target spaceborne body.

11. The satellite according to claim 1, comprising an electrostatic or magnetohydrodynamic device for accelerating the plasma jet created by the impact of the one or more laser beams on the target spaceborne body.

12. The satellite according to claim 1, comprising a radiofrequency-wave device for accelerating the plasma jet created by the impact of the one or more laser beams on the target spaceborne body.

13. A space propulsion method comprising the steps of:
capturing and potentially processing a target spaceborne body; and
using the target spaceborne body as propellant for propulsion by laser ablation.
